(19) United States
(12) Patent Application Publication
(10) Pub. No.: US 2016/0109030 A1
(43) Pub. Date: Apr. 21, 2016

(54) DUAL-APPLICATION WATER SEPARATOR

(71) Applicant: Xiamen Runner Industrial Corporation, Xiamen (CN)

(72) Inventors: Bin Yang, Xiamen (CN); Jing-Ming Li, Xiamen (CN)

(21) Appl. No.: 14/883,596

(22) Filed: Oct. 14, 2015

(30) Foreign Application Priority Data
Oct. 15, 2014 (CN) 201420595432.7

(51) Int. Cl. F16K 5/04

(52) U.S. Cl. CPC F16K 5/045

(57) ABSTRACT

A dual-application water separator comprises a tube-shape water separating body, that is provided with a tube-shape main body; a water inlet tube; and a water outlet tube. Inside the tube-shape main body is sleeved with a hollow rotation axis that is rotatable, while in the rotation axis is provided with a water separating channel. The outer ends of the water inlet channel and the water outlet channel are threaded and connected to a tube-shape connector. In the water inlet channel and the water outlet channel are provided with a barrel-shape cat eye gasket, that includes a barrel-shape main body. The end of the barrel-shape main body facing the rotation axis is an arc face in close contact with the rotation axis; while the end of the barrel-shape main body facing the barrel-shape connector is a step hole indented inward.

### BACKGROUND OF THE INVENTION

1. Field of the Invention

The present invention relates to a water separator, and in particular to a dual-application water separator.

2. The Prior Arts

Presently on the market, water separator can be classified into ceramic valve core structure, and O-shape tight seal ring and hard gasket tight seal structure. The applications of ceramic valve core structure is restricted due to its fixed form, and its cost is high. While the O-shape tight seal ring and hard gasket tight seal structure has the defects that, it is liable to have abrasion, thus leading to short service life.

Therefore, presently, the design and performance of water separator is not quite satisfactory, and it leaves much room for improvement.

### SUMMARY OF THE INVENTION

In view of the problems and drawbacks of the prior art, the present invention provides a dual-application water separator, to overcome the deficiency of the existing water separator that abrasion is liable to happen between different tight seal rings, to cause water leakage.

In the present invention, cat eye gasket and spring are used in cooperation to achieve elastic tight seal. Meanwhile, water separation is realized through different channels by means of a rotation axis, in achieving reliability, low cost, and long service life, thus having a good competitiveness in the market.

A major objective of the present invention is to provide a dual-application water separator, characterized in that, it includes a water separating body; that is provided with a tube-shape main body; a water inlet tube, that is extended into the water separate body to form a water inlet channel; and a water outlet tube, that is extended in the water separate body to form a water outlet channel. Inside the tube-shape main body of the water separating body is sleeved with a hollow rotation axis that is rotatable, while in the rotation axis is provided with a water separating channel. The outer ends of the water inlet channel and the water outlet channel are threaded and connected to a tube-shape connector. In the water inlet channel and the water outlet channel are provided with a barrel-shape cat eye gasket, that includes a barrel-shape main body. The end of the barrel-shape main body facing the rotation axis is an arc face in close contact with the rotation axis; while the other end of the barrel-shape main body facing the barrel-shape connector is a step hole indented inward. In the step hole indented inward of the cat eye gasket is provided with a spring. One end of the spring acts on the step face indented inward; while its other end acts on the hole flat end in the tube-shape connector.

Further, three holes are provided on the cylindrical face of the rotation axis. When the first hole of the rotation axis is connected with the water inlet channel of the water separating body, the second hole is connected to the water outlet channel of the water separating body to form a first water separating channel. The front end of the tube-shape main body of the water separating body is provided with a water separating port, while in the rotation axis is provided with a water separating channel connected and in communication with the water separating port. The third hole is provided on the rotation axis, connected and in communication with the water inlet channel of the water separating body, to form a second water separating channel. A discharge slot indented inward is provided on the outer surface of the rotation axis, to perform discharge through rotation and switching.

Moreover, the water separating body is provided with a water inlet channel and a water outlet channel. The cross sections of the water inlet channel and a water outlet channel are of an elliptical shape, while the cross section of the barrel-shape cat eye gasket is also of an elliptical shape, to ensure close contact between the front section arc face of the cat eye gasket and the cylindrical face of the rotation axis.

In addition, one end of the rotation axis is connected to a connection rod. The connection rod and the rotation axis are fixed to the water separating body through a press cap. The connection rod is connected to a handle driving the connection rod into rotation.

Further, through its barbs, the press cap fixes the rotation axis and the connection rod onto the water separating body. On the outer wall of the rotation axis is provided with ribs for restricting position, to act in cooperation with a position restricting slot of the water separating body, in achieving position restriction. The outer perimeter of the connection rod is provided with rotation slot. On the inner wall of the rotation axis is provided with rotation rib acting in cooperation with rotation slot, such that the connection rod drives the rotation axis into rotation.

Compared with the existing technology, the present invention has the following advantages: through the tight seal of the cat eye gasket and the spring in the water inlet channel and the water outlet channel respectively, the defects of water leakage of the prior art caused by abrasion of different tight seal rings can be avoided. In addition, water separation is realized easily through rotation axis by means of different water channels, in achieving reliability, low cost, and long service life.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is an exploded view of a dual-application water separator according to the present invention;

FIG. 2 is a cross section view of a dual-application water separator according to the present invention;

FIG. 3 is a schematic diagram of water flow (first water separating channel) of a dual-application water separator of FIG. 2 in operation according to the present invention;

FIG. 4 is a side view of a dual-application water separator of FIG. 3 in operation according to the present invention;

FIG. 5 is a schematic diagram of water flow (the second water separating channel) of a dual-application water separator of FIG. 2 in operation according to the present invention;

FIG. 6 is a side view of a dual-application water separator of FIG. 5 in operation according to the present invention;

FIG. 7 is a perspective view of a cat eye gasket according to the present invention; and

FIG. 8 is a side view of a cat eye gasket according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

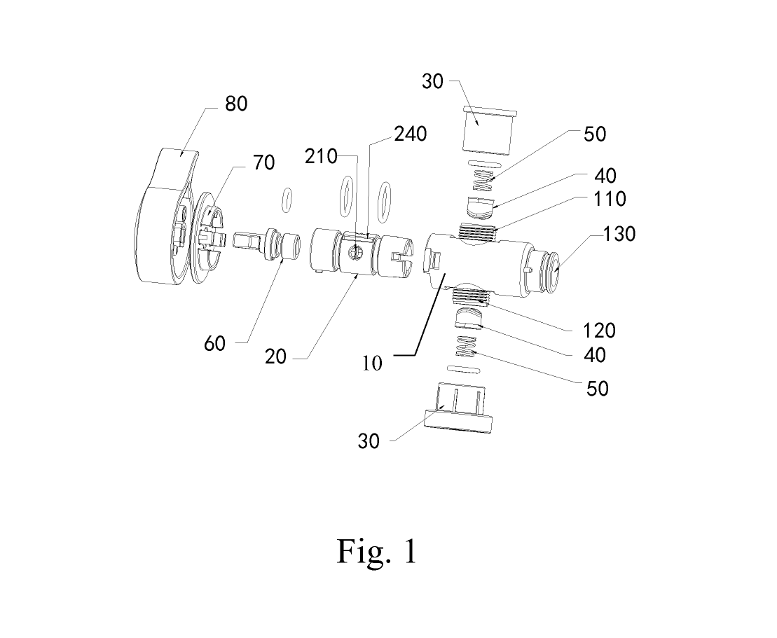

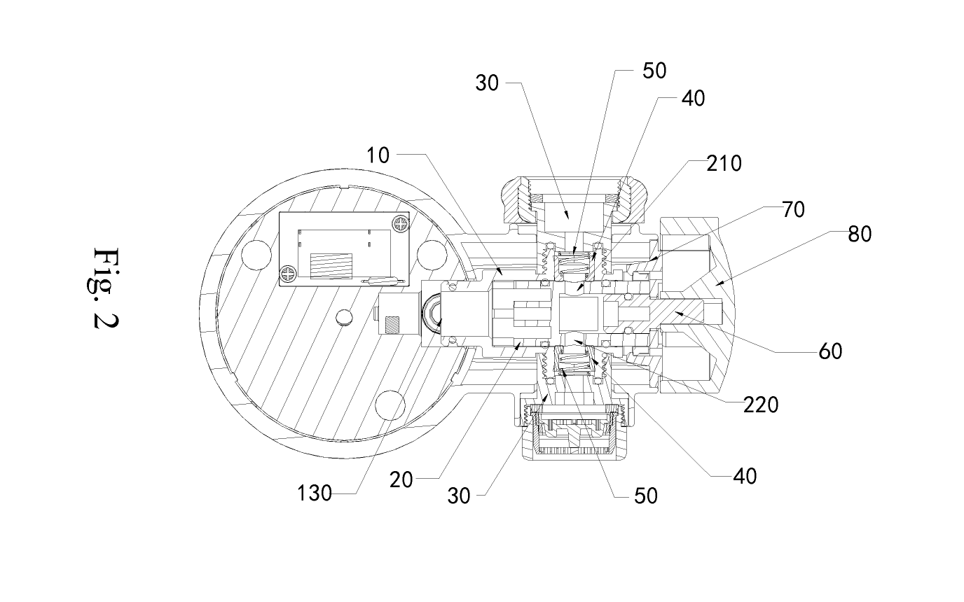

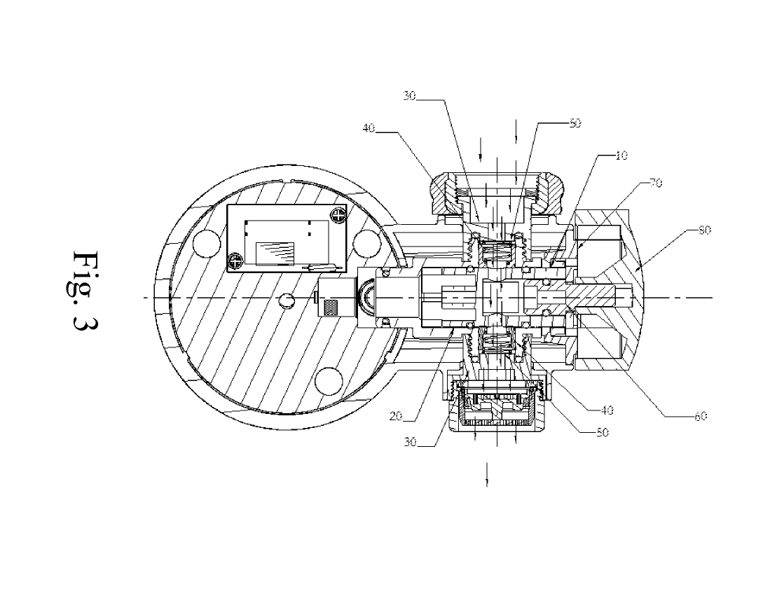

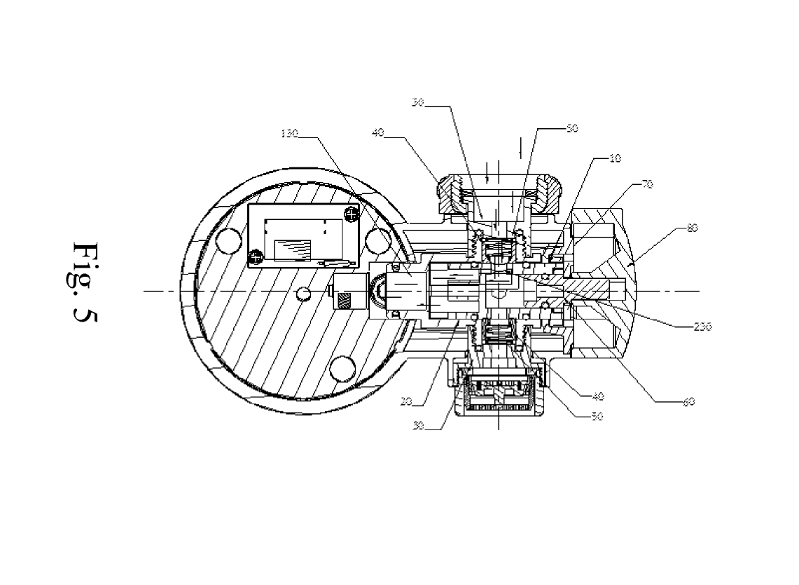

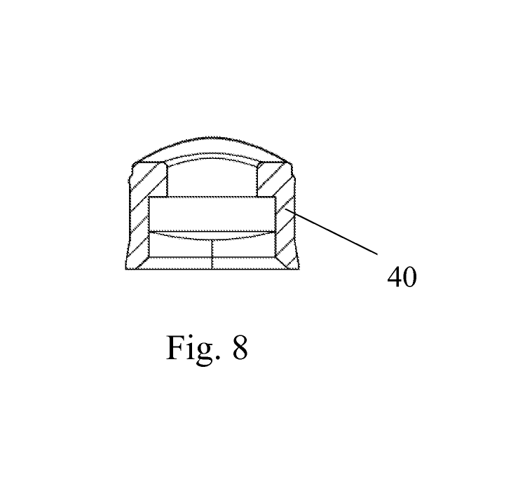

Refer to FIGS. 1 to 8 respectively for an exploded view of a dual-application water separator according to the present invention; a cross section view of a dual-application water separator according to the present invention; a schematic diagram of water flow (first water separating channel) of a dual-application water separator of FIG. 2 in operation according to the present invention; a side view of a dual-application water separator of FIG. 3 in operation according to the present invention; a schematic diagram of water flow (the second water separating channel) of a dual-application water separator of FIG. 2 in operation according to the present invention; a side view of a dual-application water separator of FIG. 5 in operation according to the present invention; a perspective view of a cat eye gasket according to the present invention; and a perspective view of a cat eye gasket according to the present invention.

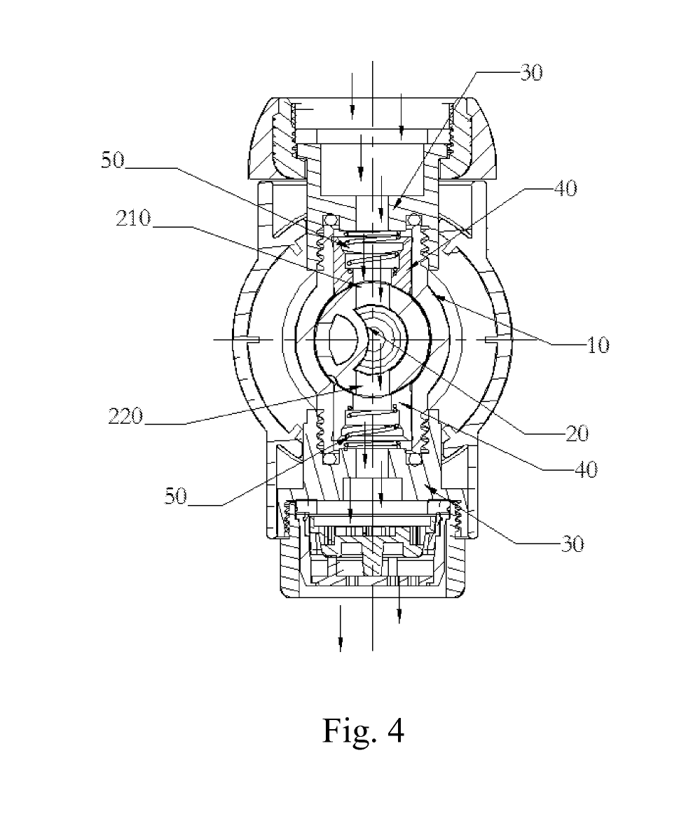

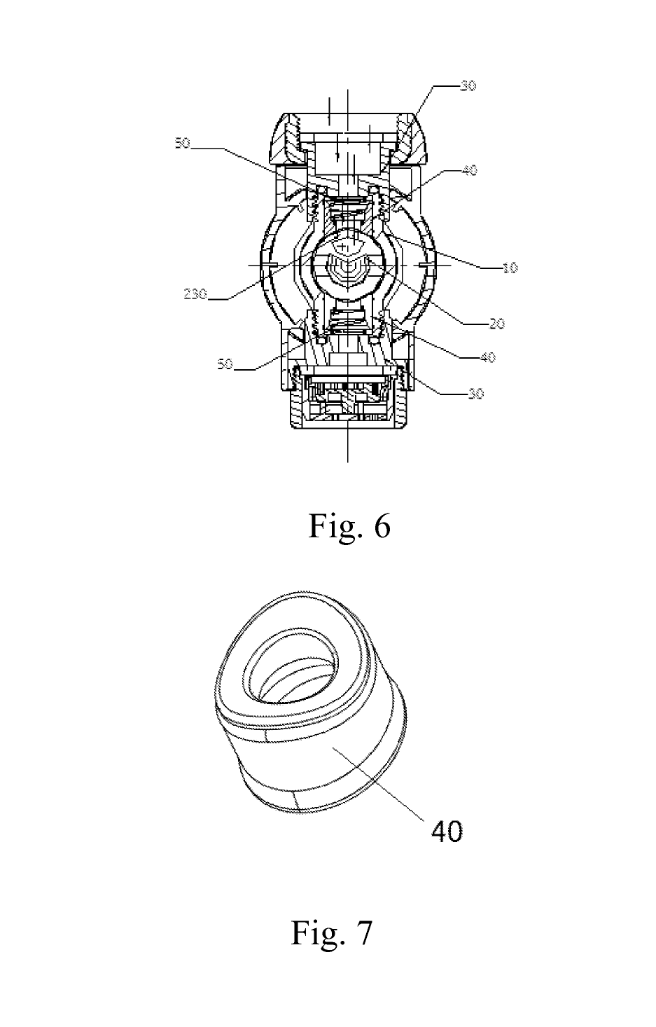

As shown in FIGS. 1 to 8, the dual-application water separator 1 includes: a tube-shape water separating body 10. Along the outer wall of the water separating body 10 is provided with a water inlet tube 110, that is extended into the water separate body 10 to form a water inlet channel; and a water outlet tube 120, that is extended in the water separate body 10 to form a water outlet channel. Inside the water separating body 10 is sleeved with a hollow rotation axis 20 that is rotable, while in the rotation axis 20 is provided with a water separating channel. On the rotation axis 2 is provided with a first hole 210 and a second hole 220. When the first hole 210 of the rotation axis 20 is connected and in communication with the water inlet tube 110, the second hole 220 and the water outlet tube 120 are connected to form a first water separating channel (as shown in FIGS. 3 and 4). The front end of the water separating body 10 is provided with a water separating port 130. In the rotation axis is provided with a water separating channel 230 connected and in communication with the water separating port 130. On the rotation axis 20 is provided with a third hole, connected and in communication with the water separating channel 230. When the third hole is just opposite the water inlet tube 110, the front end of the water separating channel 230 is just opposite the water separating port 130, to form a second water separating channel (as shown in FIGS. 5 and 6). On the outer surface of the rotation axis 20 is provided with a flow discharge slot 240 indented inward, to realize pressure discharge through rotation and switching processes.

The water inlet tube 110 and the water outlet tube 120 are formed integrally into a body with the water separating body 10. The outer walls of the water inlet tube 110 and the water outlet tube 120 are threaded and connected to a tube-shape connector 30. In the water inlet tube 110 and the water outlet tube 120 are provided with barrel-shape cat eye gasket 40, that includes a barrel-shape main body. An opening at one end of the barrel-shape main body facing the rotation axis is provided with a step hole indented inward. In the barrel-shape main body is provided with a spring 50. One end of the spring 50 acts on the step hole indented inward, while its other end acts on one end of the tube-shape connector 30 facing the water separating body 10.

The water separating body 10 is provided with a water inlet channel and a water outlet channel, and the cross sections of the water inlet channel and a water outlet channels are of an elliptical shape. The cross section of the barrel-shape cat eye gasket 40 is also of an elliptical shape, to ensure the close contact of the front section arc face of the barrel-shape cat eye gasket 40 and the cylindrical face of the rotation axis. Inside the barrel-shape cat eye gasket 40 is provided with a spring 50, to achieve elastic contraction of the gasket 40. The elastic tight seal may reduce abrasion of the barrel-shape cat eye gasket 40, while it may compensate abrasion to achieve tight seal, to avoid leakage.

The outer wall of the rotation axis 20 is provided with a position limiting rib. One end of the rotation axis is provided with a connection rod 60, while it other end is connected with a connection rod 60, the connection rod 60 and the rotation axis 20 are fixed to the water separating body 10 through the press cap 70. The connection rod 60 is connected to a handle 80 for driving the connection rod 60 into rotation. The press cap fixes the rotation axis and the connection rod onto the water separating body through barbs. On the outer wall of the rotation axis 20 is provided with positioning limiting rib, to act in cooperation with the position limiting slot of the water separating body 10, in achieving position limiting. The outer perimeter of the connection rod 60 is provided with rotable slots, while the inner wall of the rotation axis is provided with rotable rib, acting in cooperation with the slot, to drive the rotation axis to rotate through the connection rod.

The present invention can be utilized in water purification equipment, and/or bathing/sanitary equipment requiring to switch between two water input channels.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A dual-application water separator, comprising: a tube-shape water separating body, that is provided with a tube-shape main body; a water inlet tube, that is extended into the water separate body to form a water inlet channel; and a water outlet tube, that is extended in the water separate body to form a water outlet channel; inside the tube-shape main body is sleeved with a hollow rotation axis that is rotatable, while in the rotation axis is provided with a water separating channel, outer ends of the water inlet channel and the water outlet channel are threaded and connected to a tube-shape connector; in the water inlet channel and the water outlet channel are provided with a barrel-shape cat eye gasket, that includes a barrel-shape main body, the end of the barrel-shape main body facing the rotation axis is an arc face in close contact with the rotation axis; while the other end of the barrel-shape main body facing the barrel-shape connector is a step hole indented inward; in the step hole indented inward of the cat eye gasket is provided with a spring; one end of the spring acts on the step face indented inward; while its other end acts on the hole flat end in the tube-shape connector.

2. The dual-application water separator as claimed in claim 1, wherein three holes are provided in the cylindrical face of the rotation axis, when a first hole of the rotation axis is connected to the water inlet channel of the water separating body, the second hole is connected to the water outlet channel of the water separating body to form a first water separating channel, a front end of the tube-shape main body of the water separating body is provided with a water separating port, while in the rotation axis is provided with a water separating channel connected and in communication with the water separating port; the third hole is provided on the rotation axis, connected and in communication with the water inlet channel of the water separating body, to form a second water separating channel; a discharge slot indented inward is provided on an outer surface of the rotation axis, to perform pressure discharge through rotation and switching processes.

3. The dual-application water separator as claimed in claim 1, wherein the water separating body is provided with the water inlet channel and the water outlet channel, the cross sections of the water inlet channel and the water outlet channel are of an elliptical shape, while the cross section of the barrel-shape cat eye gasket is also of an elliptical shape, to ensure close contact between the front section arc face of the cat eye gasket and the cylindrical face of the rotation axis.

4. The dual-application water separator as claimed in claim 1, wherein one end of the rotation axis is connected to a connection rod, the connection rod and the rotation axis are fixed to the water separating body through a press cap, the connection rod is connected to a handle driving the connection rod into rotation.

5. The dual-application water separator as claimed in claim 4, wherein through its barbs, the press cap fixes the rotation axis and the connection rod onto the water separating body, on an outer wall of the rotation axis is provided with ribs for restricting positions, to act in cooperation with a position restricting slot of the water separating body, in achieving position restriction, outer perimeter of the connection rod is provided with rotation slot, on an inner wall of the rotation axis is provided with rotation rib acting in cooperation with rotation slot, such that the connection rod drives the rotation axis into rotation.
